(19) United States
(12) Patent Application Publication
(10) Pub. No.: US 2011/0286210 A1
(43) Pub. Date: Nov. 24, 2011

(54) LED LIGHT SOURCE IN A SINGLE-PACKAGE FOR RAISING COLOR-RENDERING INDEX

(75) Inventors: Ching-Chuan SHIUE, Taoyuan Hsien (TW); Li-Fan LIN, Taoyuan Hsien (TW); Wen-Chia LIAO, Taoyuan Hsien (TW); Shih-Peng CHEN, Taoyuan Hsien (TW); Horng-Jou WANG, Taoyuan Hsien (TW); Huang-Kun CHEN, Taoyuan Hsien (TW)

(73) Assignee: DELTA ELECTRONICS, INC., TAOYUAN HSIEN (TW)

(21) Appl. No.: 12/957,942

(22) Filed: Dec. 1, 2010

(30) Foreign Application Priority Data
May 24, 2010 (TW) 99116522

(51) Int. Cl. F21V 9/00

(52) U.S. Cl. 362/231

(57) ABSTRACT

A LED light source in a single package for raising the color-rendering index is provided. The LED light source comprises a substrate, at least one covering layer, a primary light source, and a secondary light source. The primary and the secondary light sources are formed on the substrate and coated with the at least one covering layer to provide a first output light and a second output light, respectively. The total output light is a mixed color of the first output light and the second output light.

### RELATED APPLICATIONS

This application claims priority to Taiwan Application Serial Number 99116522, filed May 24, 2010, which is herein incorporated by reference.

### BACKGROUND

1. Technical Field

The present invention relates to a light-emitting electronic apparatus. More particularly, the present invention relates to a LED light source in a single package for raising the color-rendering index.

2. Description of Related Art

The development of the high-power white light light-emitting diode (LED) leads to use for illumination. The white light LED tends to replace the conventional incandescent bulb due to its high lighting efficiency and power-saving characteristic. However, in order to make the light generated from the light source suitable for the perception of human eyes, the light source needs to have a good performance on its luminance and the color-rendering index (CRI).

The performance on the CRI of the white light LED can still not compare with the conventional incandescent bulb. Color rendering, expressed as a rating from 0 to 100 on the CRI, describes how a light source makes the color of an object appear to human eyes and how well subtle variations in color shades are revealed. The higher the CRI rating is, the better its color rendering ability. Consequently, if the CRI of the white light LED can be raised, the white light LED can have better illuminating ability.

### SUMMARY

An aspect of the present disclosure is to provide a LED light source in a single package for raising the color-rendering index. The LED light source includes a substrate, at least one covering layer, a primary light source and a secondary light source. The primary and secondary light sources are formed on the substrate and coated with the at least one covering layer to provide a first output light and a second output light, respectively. The total output light is a mixed color of the first output light and the second output light. The first output light has CIE color coordinates located within an area of a quadrilateral of the CIE 1931 chromaticity diagram from four points that are (0.29, 0.50), (0.44, 0.42), (0.37, 0.38) and (0.22, 0.40).

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a top view of a LED light source according to an embodiment of the present invention;

FIG. 1B is a sectional view of the LED light source along the dashed line A-A of FIG. 1A;

FIG. 2 is the CIE 1931 chromaticity diagram;

FIG. 3A to FIG. 3C are top views of the LED light source showing different distribution forms of the primary and the secondary light sources according to different embodiments;

FIG. 4A to FIG. 4C are top views and sectional views of the primary light source, the secondary light source and the local covering layers according to different embodiments; and

FIG. 5A and FIG. 5B are respectively a top view and a sectional view of the LED light source according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

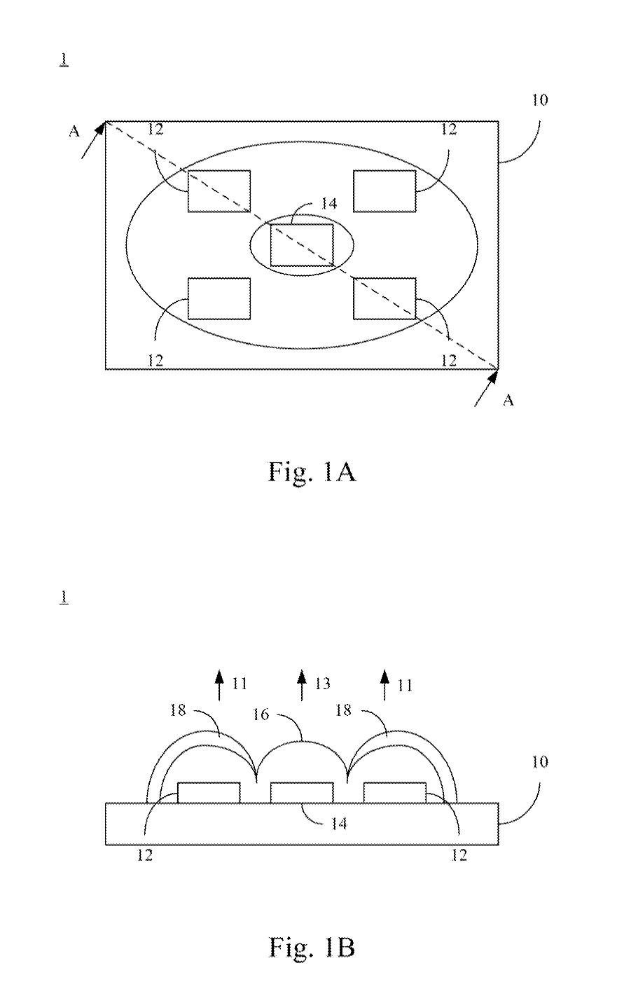

Please refer to FIG. 1A and FIG. 1B at the same time. FIG. 1A is a top view of a LED light source 1 according to an embodiment of the present invention. FIG. 1B is a sectional view of the LED light source 1 along the dashed line A-A in FIG. 1A. The LED light source 1 includes a substrate 10, at least one covering layer, a primary light source 12 and a secondary light source 14, wherein the at least one covering layer includes a first covering layer 16 and a local covering layer 18.

The primary light source 12 includes at least one first light emitting diode chip and the secondary light source 14 includes at least one second light emitting diode chip. The substrate 10 is utilized for heat dissipating and providing the primary and the secondary light sources 12 and 14 an electrical connecting mechanism. The substrate 10 can be a flat plate, a plate with a fillister, a convex surface plate or an inclined surface plate. Further, the substrate 10 can be made of copper, aluminum or ceramics. The primary light source 12 and the secondary light source 14 are driven by a direct current source or an alternating current source (not shown). In different embodiments, the primary light source 12 and the secondary light source 14 can be controlled by the same circuit of power supply or by different circuits of power supplies.

In this embodiment, the primary light source 12 is formed on the substrate 10 and coated with the first covering layer 16 and the local covering layer 18 to provide a first output light 11. The secondary light source 14 is formed on the substrate 10 and is coated with the first covering layer 16 to provide a second output light 13. The lighting efficiency of the primary light source 12 is higher than that of the secondary light source 14, wherein the lighting efficiencies of the primary light source and the secondary light sources are determined by ratios of output luminous intensities and input powers of the primary light source 12 and the secondary light source 14, respectively. The output luminous intensity ratio of the primary light source 12 to the secondary light source 14 is larger than 1.

As shown in FIG. 1A and FIG. 1B, the first covering layer 16 is formed on both the primary light source 12 and the secondary light source 14, and the local covering layer 18 is formed on the primary light source 12 and part of the first covering layer 16.

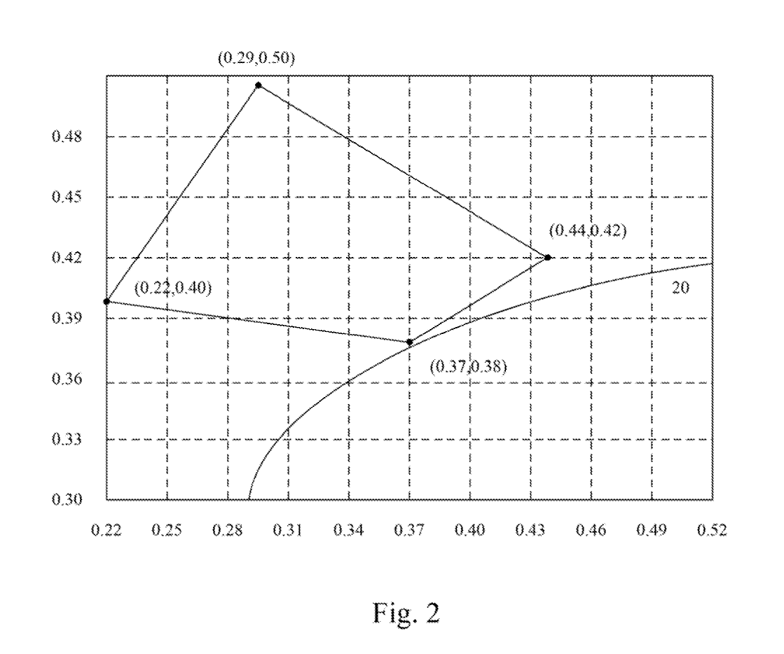

In this embodiment, the local covering layer 18 is formed on the primary light source 12 and a part of the first covering layer 16. The local covering layer 18 includes at least one transparent material and at least one mixture having at least one wavelength-converting material. The primary light source emits a first light with a first wavelength. The wavelength-converting material of the local covering layer, such as phosphor, absorbs a part of the first light emitted by the primary light source 12 and emits another light with a second wavelength longer than that of the first light. The first output light is a mixed color of the first light and the second light. Both the first covering layer 16 and the local covering layer 18 can include at least one transparent material. The refractive index of the transparent material is larger than 1. The refractive index of the LED chip is about 2 and the refractive index of the air is 1. Therefore, the light-emitting efficiency of the light emitted from the LED chip to the air decreases due to the difference of the refractive index of the LED chip and the air. Thus, the first covering layer 16 formed on the primary and the secondary light sources 12, 14 can increase the intensity of the light refracting to the air. The primary light source 12 is coated with the first covering layer 16 and the local covering layer 18 to provide the first output light 11. The first output light 11 has CIE color coordinates located within an area of the quadrilateral of the CIE 1931 chromaticity diagram depicted in FIG. 2, wherein the area of the quadrilateral is given from four points that are (0.29, 0.50), (0.44, 0.42), (0.37, 0.38) and (0.22, 0.40).

The total output light is a mixed color of the first output light 11 and the second output light 13. The first output light 11 is generated from the primary light source 12 coated with the first covering layer 16 and the local covering layer 18 in sequence. The second output light 13 is generated from the secondary light source 14 coated with the first covering layer 16, wherein the peak wavelength of the second output light 13 is within the range of 610˜640 nm. The first covering layer 16 includes at least one transparent material and its refractive index is larger than 1. The first covering layer 16 can increase the intensity of the light refracting from the primary light source 12 and the secondary light source 14 to the air. When the color temperature of the total output light is within the range of 2700˜4000K, the average color rendering index Ra of the total output light is larger than 80 and a special color rendering index R9 of the total output light is larger than 40. Consequently, the total output light having the average color rendering index and the special color rendering index described above can present high color rendering ability such that it can reveal subtle variations in color shades when human eyes percept the light.

Please refer to Table 1 showing some statistics related to the LED light source 1 according to an embodiment of the present invention. The primary light source 12, that is, a light source 1 has a peak wavelength within the range of 449˜459 nm. Since the primary light source 12 is coated with the first covering layer 16 and the local covering layer 18, the first output light 11 (coordinates 1st output light in table 1) is obtained to have CIE color coordinates located within the area of the quadrilateral of the CIE 1931 chromaticity diagram depicted in FIG. 2. The second output light 13 (that is, wavelength source 2 in table 1) is generated according to the secondary light source coated with the first covering layer 16. The peak wavelength of the second output light 13 is within the range of 615˜640 nm. The total output light (coordinates total output light) is a mixed color of the first output light 11 and the second output light 13 having different input power (power source 2). As shown in Table 1, when the color temperature of the total output light is within the range of 2700˜4000K, the total output light has an average color rendering index Ra larger than 80 and a special color rendering index R9 larger than 40.

TABLE 1

| | | | Coordinates | Coordinates | | | | |
|---|---|---|---|---|---|---|---|---|
| Wavelength | Wavelength | Power | 1st | Total | | | | |
| source 1 | source 2 | source 2 | output light | output light | CCT | CRI | R9 | Im |
| 449 | 0 | 0 | (0.38, 0.42) | | 4250 | 59.7 | −69.5 | 98 |
| 449 | 620 | 71 | | (0.43, 0.40) | 3008 | 83.0 | 72.3 | 113 |
| 459 | 0 | 0 | (0.38, 0.43) | | 4410 | 64.3 | −64.1 | 101 |
| 459 | 615 | 73 | | (0.44, 0.40) | 2997 | 88.7 | 42.6 | 121 |
| 459 | 0 | 0 | (0.38, 0.43) | | 4410 | 64.3 | −64.1 | 101 |
| 459 | 620 | 82 | | (0.44, 0.40) | 3007 | 91.1 | 89.7 | 119 |
| 449 | 0 | 0 | (0.37, 0.43) | | 4653 | 59.0 | −87.4 | 100 |
| 449 | 615 | 82 | | (0.44, 0.40) | 3001 | 86.2 | 45.3 | 122 |
| 449 | 0 | 0 | (0.37, 0.43) | | 4653 | 59.0 | −87.4 | 100 |
| 449 | 620 | 93 | | (0.44, 0.40) | 3010 | 85.9 | 96.5 | 119 |
| 459 | 0 | 0 | (0.36, 0.44) | | 4764 | 63.8 | −81.8 | 103 |
| 459 | 615 | 91 | | (0.44, 0.41) | 3001 | 93.0 | 56.1 | 128 |
| 459 | 0 | 0 | (0.36, 0.44) | | 4764 | 63.8 | −81.8 | 103 |
| 459 | 620 | 103 | | (0.44, 0.41) | 3003 | 91.1 | 88.0 | 125 |
| 459 | 0 | 0 | (0.40, 0.42) | | 3889 | 65.6 | −40.7 | 88 |
| 459 | 620 | 48 | | (0.44, 0.40) | 2994 | 83.9 | 58.0 | 99 |
| 459 | 0 | 0 | (0.40, 0.42) | | 3836 | 65.1 | −43.2 | 89 |
| 459 | 640 | 120 | | (0.44, 0.41) | 2998 | 81.6 | 71.0 | 98 |
| 452 | 0 | 0 | (0.30, 0.46) | | 6372 | 49.1 | −181.8 | 100 |
| 452 | 615 | 152 | | (0.44, 0.41) | 2997 | 83.9 | 90.8 | 141 |
| 452 | 0 | 0 | (0.30, 0.46) | | 6372 | 49.1 | −181.8 | 100 |
| 452 | 612 | 145 | | (0.44, 0.41) | 2997 | 87.6 | 59.2 | 143 |

According to Table 1, the first output light 11 (coordinates 1st output light) having CIE color coordinates located within the area of the quadrilateral of the CIE 1931 chromaticity diagram depicted in FIG. 2 can be color-mixed with the second output light 13 having different intensity (power source 2). The total output light is located at the positions (0.43, 0.40), (0.44, 0.40) or (0.44, 0.41) of the blackbody curve 20. Further, when the color temperature of the total output light is within the range of 2700˜4000K, the total output light has an average color rendering index Ra larger than 80 and a special color rendering index R9 larger than 40. Therefore, the LED chips in a single package having different lighting efficiency and coated with suitable covering layers can accomplish a better color-rendering ability that is appropriate for the perception of the human eyes.

For example, a light (e.g. blue light) having a first wavelength emitted from the LED chip (primary light source) can pass through the local covering layer having wavelength-converting material (e.g. phosphor). The wavelength-converting material absorbs a part of the light of the first wavelength (e.g. blue light), and then emits another light of the second wavelength (e.g. yellow light). The first output light 11 is a mixed color of the unconverted light with the first wavelength and the converted light with the second wavelength. The first output light 11 is further color-mixed with the second output light 13 (wherein the peak wavelength is within the range of 615˜640 nm) to generate the total output light. When the color temperature of the total output light is within the range of 2700˜4000K, the total output light has an average color rendering index Ra that is 80 or more and a special color rendering index R9 that is 40 or more.

In an embodiment, the spacing between each of the primary light source 12 and the secondary light source 14 is larger than 0.1 mm to prevent the light from one chip shaded by the lights from the other chips.

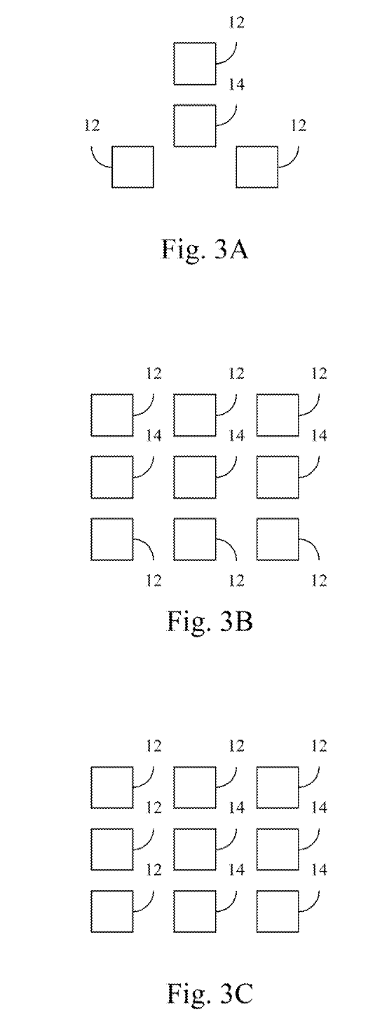

The primary and the secondary light sources 12 and 14 can provide an ultraviolet light, a purple light, a blue light, a green light, a yellow light, an orange light or a red light, respectively. After the peak wavelength-conversion is provided by the local covering layer, the CRI described above can be made. In different embodiments, the number and the distribution form of the primary and secondary light sources 12 and 14 can be different. Please refer to FIG. 3A, the LED light source 1 can have three primary light sources 12 and one secondary light source 14, wherein the three primary light sources 12 surrounds the secondary light sources 14. In FIG. 3B, the LED light source 1 has six primary light sources 12 and three secondary light sources 14, wherein the light sources are divided into two groups such that each three of the primary light sources 12 are located on the two sides of the three secondary light sources 14. In FIG. 3C, the LED light source 1 has five primary light sources 12 and four secondary light sources 14, wherein the four secondary light sources 14 gather together such the five primary light sources 12 are located on two sides of the secondary light sources 14. In other embodiments, the distribution form of the primary light source 12 and the secondary light source 14 can make the primary light source 12 surround the secondary light source 14, make the secondary light source 14 surround the primary light source 12, make the primary light source 12 and the secondary light source 14 interlace with each other, make the primary light source 12 and the secondary light source 14 located symmetrically, or make the primary light source 12 and the secondary light source 14 located randomly. Those skilled in the art are able to make various modifications and variations for the structure of the present invention without departing from the scope or spirit of the invention to accomplish the best output result of the total output light.

The first covering layer 16 and the local covering layer 18 can be a single-layer or a multi-layer structure, respectively. The first covering layer 16 and the local covering layer 18 can be a flat plate, a concave plate, a convex plate, a regular surface plate, an irregular surface plate, a mirror surface plate, a ladder-shaped plate, a round-shaped plate or a polygon shaped plate respectively. Further, the first covering layer 16 and the local covering layer 18 can be formed by dispensing, spraying, screen printing, mold filling, stamp printing or transpose reprint.

If the first covering layer 16 and the local covering layer 18 include a mixture of scattering material, photoluminescence material, wavelength-converting material, non-lattice material or a combination thereof, the mixture can be uniformly distributed, non-uniformly distributed, gradually distributed with a concentration gradient, upper centralized or lower centralized.

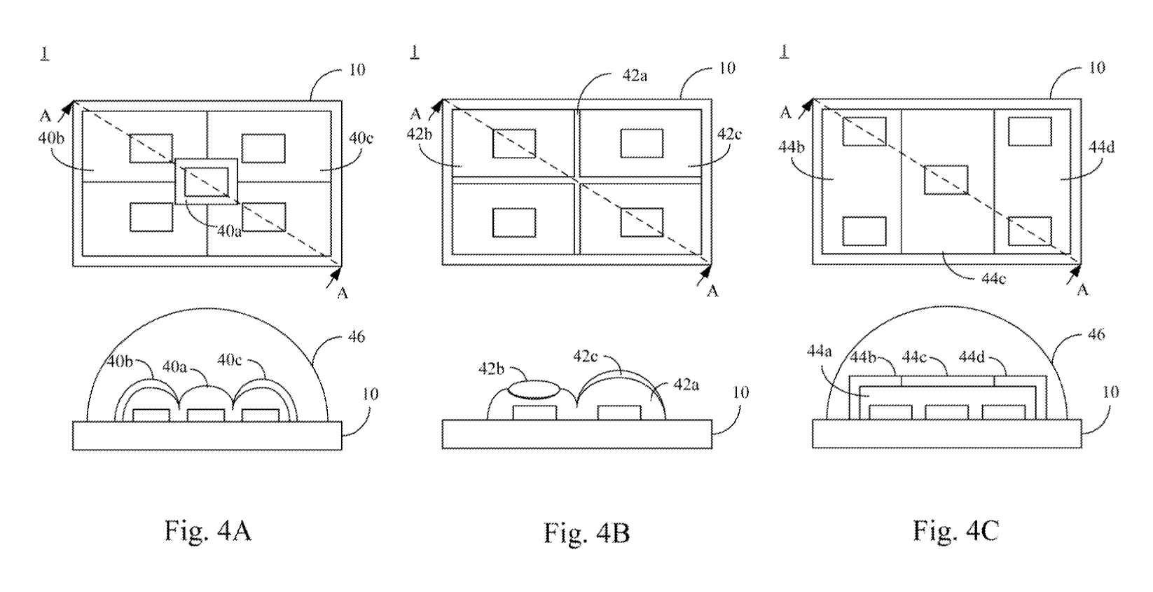

FIG. 4A to FIG. 4C are the top views and cross-sectional views of the primary light source, the secondary light source and the covering layers in different embodiments. FIG. 4A to FIG. 4C show different arrangement of the covering layers, and the primary light source and the secondary light source are not labeled here.

As shown in FIG. 4A, the LED light source 1 includes three covering layers 40a, 40b and 40c having a curve-shaped single-layer structure disposed on the primary light source and the secondary light source. As shown in FIG. 4B, the LED light source 1 includes three covering layers 42a, 42b and 42c, wherein the covering layers 42a and 42b have a complementary structure (convex/concave), and the covering layer 42c is a curve-shaped single-layer structure. As shown in FIG. 4C, the LED light source 1 includes four covering layers 44a, 44b, 44c and 44d. The covering layers 40b, 40c, 42b, 42c, 44b, 44c and 44d including different mixture can be disposed on different positions of the chips to convert wavelength of the lights from the LED chips having the same wavelength or different wavelengths. The converted lights are color-mixed in the same package. Different mixture absorbs the lights having different wavelengths. However, the absorbed light can be converted by the mixture only when the absorbed light has the corresponding wavelength. When the light absorbed by the mixture does not have the corresponding wavelength, the lighting efficiency of the LED will decreases. In other words, if the LED light source generating the lights having the same wavelength is coated with different covering layers containing different mixture, the mixture may not perform the peak wavelength-converting mechanism after absorbing the lights and may decrease the lighting efficiency since the lights not having the corresponding wavelength are absorbed. Thus, the covering layers containing the mixture is limited by the peak wavelength of the light generated by the LED light source.

In order to avoid the limitation described above, different covering layers having different mixture is selected to be coated on the LED light sources having the corresponding wavelength such that the lights generated by the LED light sources can be converted to the output lights having better lighting efficiency. Furthermore, the output lights can be hybridized to become the total output light having the best lighting efficiency. It will be apparent to those skilled in the art that various modifications and variations for the structure of the present invention can be made without departing from the scope or spirit of the invention. On the covering layers of each embodiment, a diffusing element 46 can be disposed to obtain a better output result, as depicted in FIG. 4A and FIG. 4C.

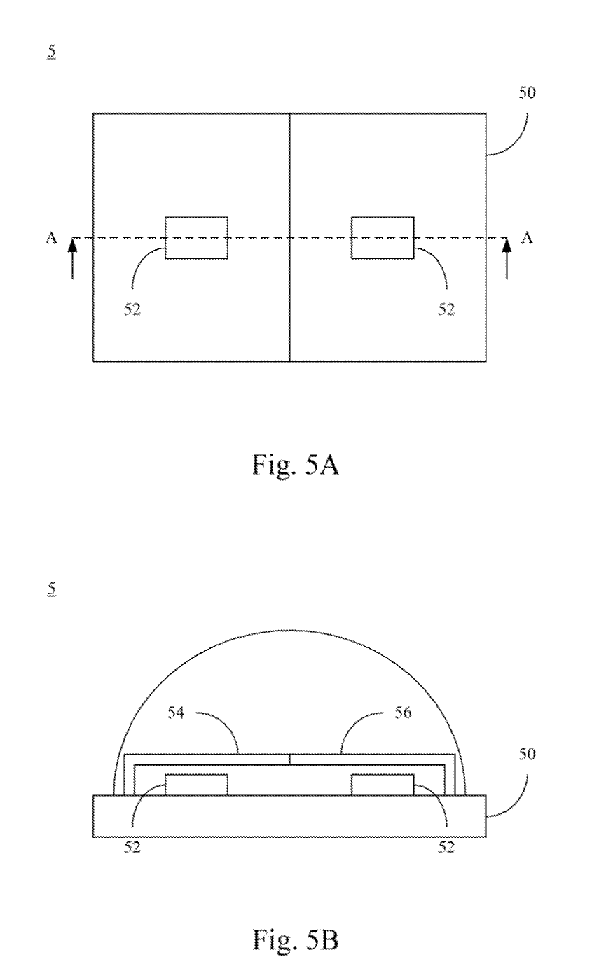

Please refer to FIG. 5A and FIG. 5B, both of which are the top view and the cross-sectional view of the LED light source 5 in another embodiment of the present invention. The LED light source 5 includes a substrate 50, two LED chips 52 and two local covering layers 54 and 56. The LED chips 52 are formed on the substrate 50 to provide the same output light (not shown). The LED chips 52 are further coated with the two local covering layers 54 and 56, respectively to generate different wavelength-converted lights. Though, the two LED chips 52 generate the same output light having the same wavelength, the local covering layers 54 and 56 coated thereon can convert the output lights into different wavelength-converted lights. The peak wavelength-converted lights are further hybridized to become the total output light, wherein when the color temperature of the total output light is within the range of 2700˜4000K, the total output light has an average color rendering index Ra that is 80 or more and a special color rendering index R9 that is 40 or more.

It's noticed that the total output light is a mixed color of at least one primary light source and at least one secondary light source, both of which are coated with at least one covering layers and/or local covering layers.

The advantage of the LED light source of the present invention is to utilize the combination of the light source and the at least one covering layer in a single package to generate the output lights having different wavelengths and intensities. The first and the second output lights are further color-mixed to become the total output light, wherein when the color temperature of the total output light is within the range of 2700˜4000K, the total output light has an average color rendering index Ra that is 80 or more and a special color rendering index R9 that is 40 or more.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A LED light source in a single package for raising the color-rendering index, comprising:
a substrate;
at least one primary light source formed on a surface of the substrate;
at least one secondary light source formed on the surface of the substrate; and
at least one covering layer, wherein the primary light source is coated with the at least one covering layer to provide a first output light and the secondary light source is coated with the at least one covering layer to provide a second output light;
wherein a total output light is a mixed color of the first output light and the second output light.

2. The LED light source of claim 1, wherein the first output light has CIE color coordinates located within an area of a quadrilateral of the CIE 1931 chromaticity diagram from four points that are (0.29, 0.50), (0.44, 0.42), (0.37, 0.38) and (0.22, 0.40).

3. The LED light source of claim 2, wherein the peak wavelength of the second output light is within a range of 610˜640 nm.

4. The LED light source of claim 1, wherein the color temperature of the total output light is within a range of 2700˜4000K, an average color rendering index Ra of the total output light is larger than 80 and a special color rendering index R9 of the total output light is larger than 40.

5. The LED light source of claim 1, wherein the at least one covering layer comprises a first covering layer and a local covering layer, the primary light source is coated with the first covering layer and the local covering layer in sequence to provide a first output light, and the secondary light source is coated with the first covering layer to provide a second output light.

6. The LED light source of claim 5, wherein the first covering layer and the local covering layer comprises at least one transparent material.

7. The LED light source of claim 6, wherein the local covering layer further comprises at least one mixture having at least one wavelength-converting material.

8. The LED light source of claim 5, wherein the primary light source emits a first light with a first wavelength, the wavelength-converting material of the local covering light absorbs a part of the light and emits a second light with a second wavelength longer than that of the first light, and the first output light is a mixed color of the first light and the second light.

9. The LED light source of claim 1, wherein the substrate comprises a flat plate, a plate with a fillister, a convex surface plate or an inclined surface plate, and the substrate comprises copper, aluminum or ceramics.

10. The LED light source of claim 1, wherein a lighting efficiency of the primary light source is higher than that of the secondary light source, and the lighting efficiencies of the first light source and the second light source are determined by ratios of output luminous intensities and input powers of the primary light source and the secondary light source, respectively, and the output luminous intensity ratio of the primary light source to the secondary light source is larger than 1.

11. The LED light source of claim 1, wherein the primary light source comprises at least one first light emitting diode chip and the secondary light source comprises at least one second light emitting diode chip.

12. The LED light source of claim 1, wherein the primary light source and the secondary light source provides an ultraviolet light, a purple light, a blue light, a green light, a yellow light, an orange light or a red light, respectively.

13. The LED light source of claim 1, wherein a spacing between each of the primary light source and the secondary light source is larger than 0.1 mm.

14. The LED light source of claim 1, wherein the distribution form of the primary light source and the secondary light source is to make the primary light source surround the secondary light source, to make the secondary light source surround the primary light source, to make the primary light source and the secondary light source interlaced with each other, to make the primary light source and the secondary light source located symmetrically, or to make the primary light source and the secondary light source located randomly.

15. The LED light source of claim 1, wherein the covering layer is a single-layer or a multi-layer structure.

16. The LED light source of claim 1, wherein the covering layer comprises at least one transparent material.

17. The LED light source of claim 1, wherein the covering layer comprises at least one mixture of at least one scattering material, wavelength-converting material, non-lattice material or a combination thereof, and the mixture is uniformly distributed, non-uniformly distributed, gradually distributed with a concentration gradient, upper centralized or lower centralized.

18. A LED light source in a single package for raising the color-rendering index, comprising:
a first output light; and
a second output light;
wherein a total output light is a mixed color of the first output light and the second output light; and
wherein the first output light has CIE color coordinates located within an area of a quadrilateral of the CIE 1931 chromaticity diagram from four points that are (0.29, 0.50), (0.44, 0.42), (0.37, 0.38) and (0.22, 0.40).

19. The LED light source of claim 18, wherein the peak wavelength of the second output light is within a range of 610˜640 nm.

20. The LED light source of claim 18, wherein when a color temperature of the total output light is within a range of 2700˜4000K, an average color rendering index Ra of the total output light is larger than 80 and a special color rendering index R9 of the total output light is larger than 40.
